(19) United States
(12) Patent Application Publication
(10) Pub. No.: US 2026/0110588 A1
(43) Pub. Date: Apr. 23, 2026

(54) MULTI-MEDIUM LARGE-DIAMETER FIDELITY SAMPLING APPARATUS AND SAMPLING METHOD

(71) Applicant: GUANGDONG LABORATORY OF SOUTHERN OCEAN SCIENCE AND ENGINEERING (GUANGZHOU), Guangdong (CN)

(72) Inventors: Jingchun FENG, Guangdong (CN); Si ZHANG, Guangdong (CN); Yan XIE, Guangdong (CN); Zhifeng YANG, Guangdong (CN)

(73) Assignee: GUANGDONG LABORATORY OF SOUTHERN OCEAN SCIENCE AND ENGINEERING (GUANGZHOU), Guangdong (CN)

(21) Appl. No.: 19/365,233

(22) Filed: Oct. 22, 2025

(30) Foreign Application Priority Data
Oct. 22, 2024 (CN) 202411478001.7

(51) Int. Cl. G01M 3/04

(52) U.S. Cl. CPC G01M 3/04

(57) ABSTRACT

The present invention discloses a multi-medium large-diameter fidelity sampling apparatus and sampling method, and relates to the field of deep-sea sampling. The apparatus includes: a methane concentration detection array, configured to detect methane leakage situation at a target sampling site and generate methane detection information; a first control module, configured to determine SMTZ depth information at the target sampling site based on the methane detection information, and further configured to determine a first control instruction based on the SMTZ depth information; and a sample collection module, configured to perform pressure-retaining sampling in response to the first control instruction, and further configured to determine sample thickness information, and to release the sample and/or perform secondary sampling based on a second control instruction determined by the first control module in response to the sample thickness information.

### CROSS-REFERENCE TO RELATED APPLICATION

This application claims the priority benefit of China Application No. 202411478001.7, filed on October 22, 2024. The entirety of the above-mentioned patent application is hereby incorporated by reference herein and made a part of this specification.

### TECHNICAL FIELD

The present invention relates to the technical field of deep-sea sampling, and more specifically, to a multi-medium large-diameter fidelity sampling apparatus and sampling method.

### BACKGROUND

Deep-sea regions account for 92.4% of the ocean area and constitute the main part of the ocean. The deep sea is characterized by extremely high pressure, low/high temperature, high salinity, strong reduction conditions, and other unique properties, and is rich in resources such as oil and gas reservoirs, biological resources, and minerals. However, due to the extreme challenges of deep-sea exploration and the limitations of deep-sea equipment technology, human understanding of the deep sea is still very limited. The deep-sea shallow sediment-seawater interface is an important region for the migration and exchange of marine substances, as well as the main active zone for deep-sea organisms. It serves as a key carrier for analyzing the substance migration and transformation and the evolution of extreme ecosystems. In-depth research on the deep-sea shallow multi-medium environment holds great significance for clarifying the migration and circulation processes of marine substances and revealing the role of deep-sea organisms in these processes. Especially in seabed areas rich in oil and gas resources, gaseous methane generated by the decomposition of natural gas hydrates migrates along fissures to the seabed and seeps out, providing nutrients for chemosynthetic microorganisms and fostering the development of unique seabed ecosystems such as cold seeps and hydrothermal vents.

In cold seeps, hydrothermal vents, and other regions rich in oil and gas resources, the upward migration of fluids containing hydrocarbons (such as methane) caused by the decomposition of natural gas hydrates provides nutrients for special seabed ecosystems, and the leaked methane migrates upward through the sediment-seawater interface into seawater, and ultimately possibly into the atmosphere. Methanotrophic microorganisms in sediments of methane leakage regions utilize and transform leaked methane, thereby effectively blocking the upward migration of methane. These microorganisms are thus referred to as the "barrier" against methane leakage. The microorganisms convert methane to bicarbonate via the AOM (anaerobic oxidation of methane) process, and bicarbonate is ultimately transformed into carbonate rocks, thereby sequestering carbon in the seabed. The AOM reaction is one of the most fundamental reactions for substance transformation and circulation in oil and gas seepage regions. The main area where this reaction occurs is known as the SMTZ (sulfate-methane transition zone). As the intensity of methane leakage varies, the SMTZ exhibits different depths; and the great methane leakage intensity indicates the shallow SMTZ interface. Precise localization and in situ sampling of the SMTZ region are necessary ways for studying fundamental environmental and ecological scientific issues related to the AOM reaction and the frontier fundamental scientific issues of cold seeps. However, current deep-sea sediment samplers have low precision and small sampling volume, which is prone to disturbance during sampling. After sampling, relevant components and microbial community composition can be simply detected. This cannot support subsequent studies on the spatial distribution of changes in related environmental factors, microbial community composition and abundance.

### SUMMARY

To overcome the shortcomings of low sampling precision and small sampling volume in the prior art, the present invention provides a multi-medium large-diameter fidelity sampling apparatus.

To solve the above technical problems, the technical solutions of the present invention are as follows:

In a first aspect, a multi-medium large-diameter fidelity sampling apparatus is provided, and includes:

a methane concentration detection array, configured to detect methane leakage situation at a target sampling site and generate methane detection information;

a first control module, configured to determine SMTZ depth information at the target sampling site based on the methane detection information; and further configured to determine a first control instruction based on the SMTZ depth information; and

a sample collection module, configured to perform pressure-retaining sampling at the target sampling site in response to the first control instruction; and further configured to determine sample thickness information of the sample collected, and to release the sample and/or perform secondary sampling based on a second control instruction determined by the first control module in response to the sample thickness information.

In a second aspect, a multi-medium large-diameter fidelity sampling method is provided and applied to the apparatus described in the first aspect, and includes:

enabling a methane concentration detection array to penetrate into sediments at a target sampling site, obtaining methane leakage situation at different depths at the target sampling site, and generating methane detection information;

enabling a first control module to determine SMTZ depth information in response to the methane detection information; wherein the SMTZ depth information is used to indicate a SMTZ depth region;

enabling the first control module to generate a first control instruction and send the first control instruction to a sample collection module based on the SMTZ depth information; wherein the first control instruction is used to instruct the sample collection module to perform pressure-retaining sampling at the target sampling site;

performing, by the sample collection module in response to the first control instruction, pressure-retaining sampling, and determining, by the sample collection module, sample thickness information of the sample collected; and

enabling the first control module to determine whether to generate a second control instruction based on the sample thickness information; wherein the second control instruction is used to instruct the sample collection module to release the sample and/or perform secondary sampling.

In a third aspect, a computer program product is provided, and includes a computer program or computer-executable instructions, where when the computer program or computer-executable instructions are executed by a processor, the method described in the first aspect is implemented.

Compared with the prior art, the beneficial effects of the technical solutions of the present invention are as follows:

The present invention provides a multi-medium large-diameter fidelity sampling apparatus, and the apparatus includes a methane concentration detection array, a first control module, and a sample collection module. During deep-sea sediment sampling, the methane concentration detection array is used to detect methane leakage at a target sampling site, thereby determining SMTZ depth information in sediments. The first control module controls the sample collection module to collect the sediments and to detect thickness information of the sample collected in real time to determine sampling quality, enabling on-demand release of samples and/or secondary sampling. Compared with the prior art, the present invention can achieve intelligent, automatic, and precise sampling based on environmental specificity at different sampling sites, significantly improve operational accuracy in a targeted manner, and achieve pressure-retaining, multi-medium, and large-volume collection of deep-sea samples. Meanwhile, by monitoring the sample thickness information in real time, rapid decisions can be made during sampling as to whether to release the sample or perform secondary sampling, thereby saving manpower and material resources and reducing deep-sea sampling costs.

### BRIEF DESCRIPTION OF DRAWINGS

FIG. 1 is a schematic structural diagram of a multi-medium large-diameter fidelity sampling apparatus in Embodiment 1 of this application;

FIG. 2 is another schematic structural diagram of a multi-medium large-diameter fidelity sampling apparatus in Embodiment 1 of this application;

FIG. 3 is a schematic structural diagram of a second control module in Embodiment 1 of this application;

FIG. 4 is a schematic structural diagram of a methane detection module in Embodiment 1 of this application;

FIG. 5 is a flowchart of a multi-medium large-diameter fidelity sampling method in Embodiment 2 of this application; and

FIG. 6 is another flowchart of a multi-medium large-diameter fidelity sampling method in Embodiment 2 of this application.

Reference numerals in the drawings are explained as follows:

1-apparatus frame; 2-second control module; 21-actuator; 22-power compartment; 31-energy storage chamber; 32-sonar; 33-sampling chamber; 34-third control module; 35-pressure-retaining cylinder; 4-methane concentration detection array; 41-third control module; 42-methane sensor; 43-protection apparatus; 5-first control module.

### DETAILED DESCRIPTION OF EMBODIMENTS

The terms "first," "second," and the like in the specification, claims, and accompanying drawings of this application are intended to distinguish between similar objects, but do not necessarily describe a specific order or sequence. It should be understood that such terms may be used interchangeably where appropriate and are merely a way to differentiate objects with the same attributes in the description of embodiments of this application. Furthermore, the terms "comprise", "include" and "have," as well as any variations thereof are intended to cover a non-exclusive inclusion, so that processes, methods, systems, products, or apparatuses including a series of units are not necessarily limited to those units, but may include other units not explicitly listed or inherent to such processes, methods, products, or apparatuses. The term "determine" broadly covers a variety of actions, including acquiring, calculating, computing, processing, deriving, investigating, searching (for example, searching in tables, databases, or other data structures), identifying, and similar actions. It also includes receiving (for example, receiving information), accessing (for example, accessing data in memory), and similar actions, as well as generating, creating, establishing, and similar actions, and parsing, selecting, picking, and similar actions, etc. Relevant definitions of other terms will be provided in the following description.

It should be noted that when an element is considered to be "connected" to another element, it may be directly connected to the another element or connected to the another element via an intervening element. Furthermore, in the following embodiments, "connection" between objects should be understood as "electrical connection," "communication connection," and the like, if there is transmission of electrical signals or data between the connected objects.

The drawings are for exemplary illustration only and shall not be construed as limitations to this patent.

To better illustrate this embodiment, certain components in the drawings may be omitted, enlarged, or reduced, and do not represent the dimensions of the actual product.

For those skilled in the art, it is understandable that certain well-known structures and descriptions thereof in the drawings may be omitted.

The technical solutions of the present invention are further illustrated below in conjunction with the drawings and embodiments.

Embodiment 1

As stated in the background, precise localization and in situ sampling of the SMTZ region are necessary ways for studying fundamental environmental and ecological scientific issues related to the AOM reaction and the frontier fundamental scientific issues of cold seeps. However, current deep-sea sediment samplers do not possess automatic control and identification functions, and have low sampling precision during sampling. In the deep-sea environment, especially in methane leakage regions, methane leakage intensity exhibits strong spatial heterogeneity, so it is difficult for existing sampling technologies to accurately collect sediments containing the SMTZ region. Moreover, due to the specificity of the deep-sea environment, maintaining the temperature and pressure of the in situ environment to avoid severe distortion of research results caused by changes in environmental conditions is an extremely important part of deep-sea research. Once sediments and seawater are removed from the in situ environment, their physical and chemical properties change, making it difficult to accurately reflect the in site geological and geochemical environment of the deep sea and posing challenges to the correct understanding of environmental attributes. Non-pressure-retaining sampling easily leads to loss of gaseous components, changes in oxidation states, and decomposition of organic components in the sample. More importantly, environmental conditions such as temperature and pressure have a significant impact on marine organisms, especially on the composition and abundance structure of microbial communities. After the microorganisms are removed from the in situ environment, even brief loss of pressure or temperature can result in substantial differences between physiological and ecological characteristics of deep-sea organisms and those in deep-sea in situ environment. Moreover, a depressurization process may even directly cause the death of some microorganisms.

Currently, diameters of deep-sea sediment samplers are basically below 10 cm and generally around 6 cm. Small-scale, small-volume pressure-retaining sediment sampling technology is less difficult and relatively easy to be implemented, but there are obvious technical defects in actual scientific research. Due to the small sampling volume, the sampling equipment is prone to disturbance during sampling; after sampling, relevant components and microbial community composition can only be simply detected. This cannot support subsequent studies on the spatial distribution of changes in related environmental factors, microbial community composition and abundance. It should be emphasized that large-scale, large-volume sampling can better simulate the true in situ environment, and larger-scale sampling is also an important way to increase the fidelity and authenticity of indoor simulation experiments. Pressure-retaining sampling cannot be performed by the large-volume deep-sea sampling technology in the prior art, and breakthroughs in large-diameter sediment pressure-retaining sampling have not yet been achieved and are urgently needed. In addition, the deep-sea environment is a multi-phase, multi-component, strongly coupled coexisting environment. Single-phase sampling and single-phase simulation technologies for the deep-sea environment cannot explain multi-sphere interaction processes. In situ sampling technology for deep-sea multi-medium (sediments, water, gas, and organisms) environments is a key technical requirement for in-depth understanding of the mechanisms of deep-sea multi-interface environmental effects.

The inventors have found that various existing deep-sea sediment samplers are highly random and cannot achieve precise and targeted sampling of regions with different methane leakage intensities based on the specificity of sampling sites. It is also difficult for the existing deep-sea sediment samplers to achieve pressure-retaining, large-scale, large-volume multi-medium sampling. Non-pressure-retaining sampling causes distortion of environmental indicators and changes in biological status, seriously affecting the authenticity of subsequent scientific research. Small-scale, small-volume pressure-retaining sampling can maintain stable environmental indicators and biological status, the small-scale sampling limits subsequent studies on the spatial distribution of relevant indicators in indoor simulation experiments, and disturbed parts during sampling account for a large proportion of the total sample, which also leads to varying degrees of distortion in research results. Furthermore, existing sampling apparatuses are unable to determine sampling quality in real time after sampling. If poor sampling results are discovered in subsequent research, a large amount of manpower and material resources will be wasted.

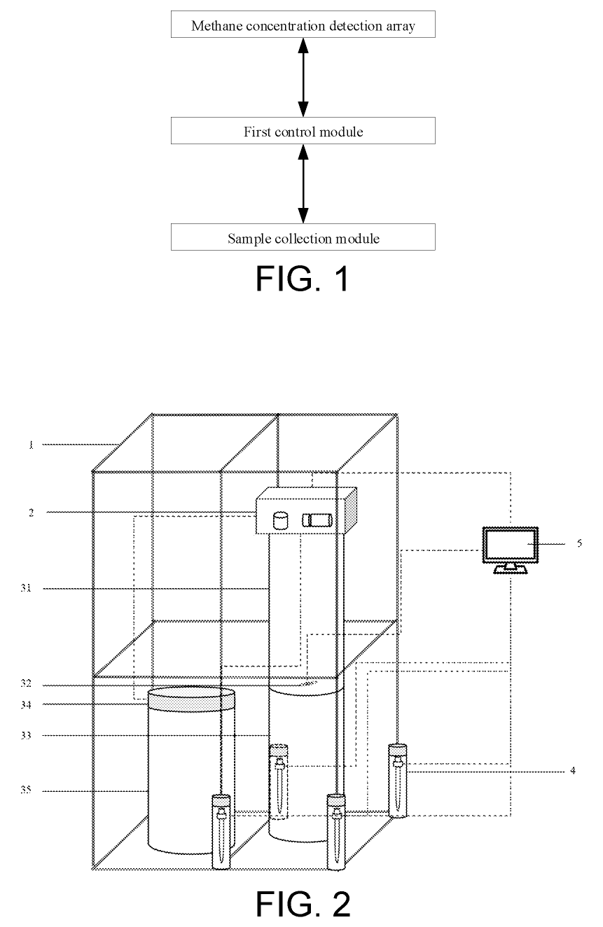

To solve the above problems, this embodiment provides a multi-medium large-diameter fidelity sampling apparatus. Referring to FIG. 1, the apparatus includes:

a methane concentration detection array, configured to detect methane leakage situation at a target sampling site and generate methane detection information;

a first control module, configured to determine SMTZ depth information at the target sampling site based on the methane detection information; and further configured to determine a first control instruction based on the SMTZ depth information; and

a sample collection module, configured to perform pressure-retaining sampling at the target sampling site in response to the first control instruction; and further configured to determine sample thickness information of the sample collected, and to release the sample and/or perform secondary sampling based on a second control instruction determined by the first control module in response to the sample thickness information.

The sampling apparatus provided in this embodiment enables precise collection of multi-medium, large-volume, fidelity samples from special deep-sea regions. During sampling, the methane concentration detection array is used to in advance detect methane leakage situation at the target sampling site, thereby determining the true AOM reaction conditions in the sediments (such as SMTZ depth information), and facilitating subsequent precise collection of multi-medium samples encompassing the SMTZ regions. Additionally, the sample collection module detects the thickness information of the collected sample (such as the thickness of seawater and sediment collected) in real time. The first control module determines sampling quality based on the sample thickness information, thereby enabling on-demand release of samples and/or secondary sampling. Compared with the prior art, the apparatus described in this embodiment can achieve intelligent, automatic, and precise sampling based on environmental specificity at different sampling sites, significantly improve operational accuracy in a targeted manner, and achieve pressure-retaining, multi-medium, and large-volume collection of deep-sea samples. Meanwhile, by monitoring the sample thickness information in real time, rapid decisions can be made during sampling as to whether to release the sample or perform secondary sampling, thereby saving manpower and material resources and reducing deep-sea sampling costs.

Those skilled in the art should understand that a wired connection or wireless connection can be adopted between the first control module and the methane concentration detection array, and between the first control module and the sample collection module, which can be determined by those skilled in the art according to the actual deep-sea environment.

In some preferred embodiments, referring to FIG. 2, the sample collection apparatus includes:

a sampling chamber, configured to perform sampling operations at the target sampling site and store the sample collected;

a sonar, provided within the sampling chamber, configured to determine whether the sample has been successfully collected in the sampling chamber, and to determine the sample thickness information of the sample;

an energy storage chamber, configured to inject pressure and be connected to the sampling chamber via a piston to maintain the pressure of the sampling chamber;

a pressure-retaining module, configured to dock with the sampling chamber to perform pressure-retaining operations after the sampling operation is completed in the sampling chamber; and

a second control module, configured to receive the first control instruction and/or the second control instruction, and to control the sampling chamber to perform the sampling operations and/or release operations based on the first control instruction and/or the second control instruction; and further configured to generate a third control instruction to control the pressure-retaining module to perform the pressure-retaining operations after the sampling operations are completed.

It should be noted that the sampling chamber described in this embodiment is a large-diameter sampling chamber, and the methane concentration detection array, the sonar, and the pressure-retaining module are used to ensure the reliability of the sampling chamber with the enlarged sampling diameter.

It should be emphasized that, in the prior art, if the sampling diameter of the sampling chamber is directly enlarged, the large-diameter sampling technology has a greater difficulty than the small-diameter sampling technology. Due to the inability to directly determine environmental characteristics at the sampling site for targeted sampling and the inability to determine the state of samples collected, sampling failures are likely to occur without timely identification, and the samples collected may fail to meet requirements. This not only causes wasted manpower and material resources and but cannot obtain ideal experimental results. In this embodiment, the methane concentration detection array is additionally provided to accurately acquire relevant environmental information prior to sampling so as to ensure more targeted sampling. After sampling, the true status of the sample collected is obtained via relevant modules (such as sonar) to determine whether the sampling meets requirements, thereby performing direct sample release and secondary sampling on the seabed according to actual conditions, and saving manpower and materials resources, and ensuring acquisition of samples needed for experiments.

In some specific embodiments, an inner diameter of the sampling chamber is 300 mm.

In some other specific embodiments, the inner diameter of the sampling chamber is 500 mm.

Those skilled in the art should understand that the sampling chamber in this embodiment is connected to a transmission structure for moving the sampling chamber, and the second control module may control the movement of the sampling chamber by controlling an operating state of the transmission structure. As a non-limiting example, the transmission structure may be a stepper motor, a screw transmission mechanism, a hydraulic cylinder transmission mechanism, an electric cylinder transmission mechanism, and the like.

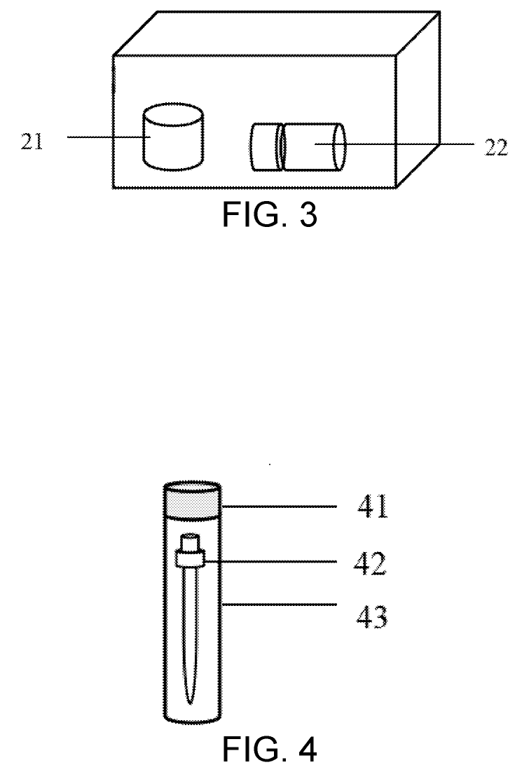

In some optional embodiments, referring to FIG. 3, the second control module includes an actuator and a power compartment. The power compartment supplies energy to the actuator; the actuator is configured to receive instructions from the first control module (namely, the first control instruction or the second control instruction) to control the sampling chamber to perform the sampling operations or release operations, and is further configured to, after the sampling operations, generate a third control instruction to control the pressure-retaining module to perform the pressure-retaining operation.

In some optional embodiments, the sample collection apparatus further includes an apparatus frame, and the second control module, the sampling chamber, the energy storage chamber, and the pressure-retaining module are provided within the apparatus frame.

In some optional embodiments, the pressure-retaining module includes a pressure-retaining cylinder and a third control module; where

one end of the pressure-retaining cylinder is provided with an opening for insertion into the sampling chamber; and

the third control module is configured to, in response to the third control instruction, control the pressure-retaining cylinder to move to a same axis as the sampling chamber, and orient the opening of the pressure-retaining cylinder towards the sampling chamber; and after the sampling chamber is placed into the pressure-retaining cylinder through the opening, the pressure-retaining cylinder is docked and sealed with the sampling chamber to complete an pressure-retaining operation.

In some other optional embodiments, the pressure-retaining module is the pressure-retaining cylinder, and the pressure-retaining cylinder is directly controlled by the second control module.

It can be understood that, in this embodiment, the pressure-retaining cylinder may also be moved by connecting the transmission structure.

In some optional embodiments, a step of releasing the sample and/or performing secondary sampling based on a second control instruction determined by the first control module in response to the sample thickness information includes:

determining, by the first control module, whether the sample collected meets preset requirements based on the sample thickness information acquired by the sonar: if the sample collected meets preset requirements, performing no operation; if the sample collected does not meet preset requirements, generating the second control instruction to instruct the sampling chamber to release the sample currently collected and/or to instruct the sampling chamber to perform sampling operation again; and

controlling, by the second control module, the sampling chamber to complete the release operation and/or the sampling operation in response to the second control instruction.

More specifically, the preset requirements may be that the sample thickness is not less than the SMTZ depth, ensuring that the sample collected contains sediments/seawater from the SMTZ region.

In some preferred embodiments, the methane detection information includes detection depth information and methane concentration information. A step of determining SMTZ depth information at the target sampling site based on the methane detection information includes:

performing linear fitting using at least three pieces of detection depth information and corresponding methane concentration information from the methane detection module to obtain a depth at which a methane concentration is zero, where the depth is an SMTZ region where an AOM reaction is most intense and referred to as the SMTZ depth information.

Those skilled in the art should understand that, in methane leakage regions, upward-leaking methane is consumed by AOM reactions in the sediments, and the concentration thereof decreases as the depth becomes shallower. In this preferred embodiment, the first control module performs linear fitting based on the collected data, detection depth information H and methane concentration information C at the site, and can calculate the depth at which the methane concentration is zero, where the depth is an SMTZ region where an AOM reaction is most intense.

In some specific embodiments, a single methane detection module measures methane concentration C1 in sediments at depth H1, methane concentration C2 in the sediments at depth H2, and methane concentration C3 in the sediments at depth H3. The precise SMTZ depth at the sampling site can be obtained by fitting these three points.

In some optional embodiments, the step of determining SMTZ depth information at the target sampling site based on the methane detection information further includes:

averaging a plurality of pieces of SMTZ depth information from a plurality of methane detection modules to obtain an average value, and taking the an average value obtained as final SMTZ depth information.

In some specific embodiments, four methane detection modules are arranged around the sampling chamber, enabling acquisition of four SMTZ depth values. Averaging these four SMTZ depth values avoids sampling quality deviations caused by accidental errors in methane concentration testing.

In some optional embodiments, the methane concentration detection array includes a plurality of methane detection modules distributed around the sample collection module. Referring to FIG. 4, each methane detection module includes:

a methane sensor, configured to collect methane concentration information in sediments at the target sampling site;

a third control module, configured to control the methane sensor to penetrate into the sediments to obtain methane concentration information in sediments at different depths; and further configured to send the methane concentration information and corresponding detection depth information to the first control module; and

a protection apparatus, configured to accommodate the third control module and the methane sensor.

### EMBODIMENT 2

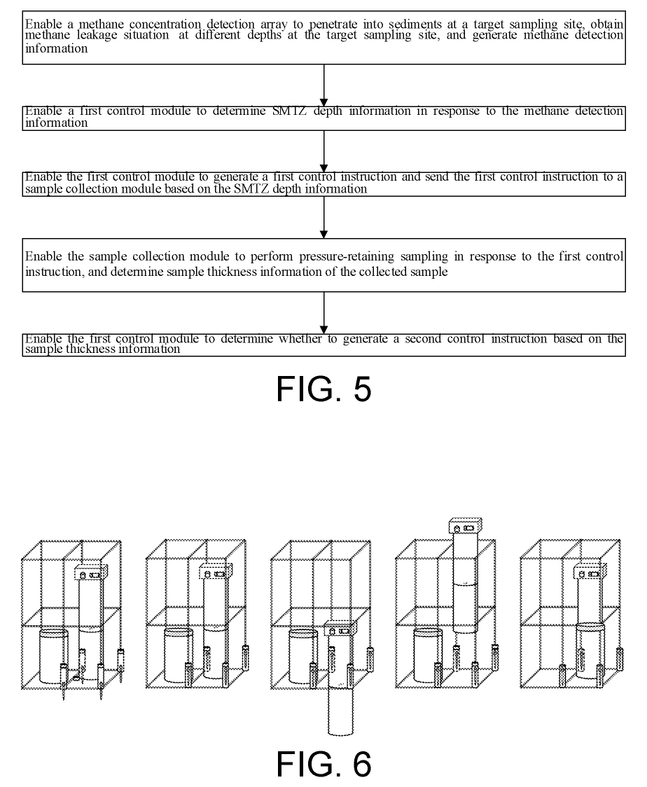

A multi-medium large-diameter fidelity sampling method is provided and applied to the apparatus provided in Embodiment 1. Referring to FIG. 5, the method includes :

enabling a methane concentration detection array to penetrate into sediments at a target sampling site, obtaining methane leakage situation at different depths at the target sampling site, and generating methane detection information;

enabling a first control module to determine SMTZ depth information in response to the methane detection information; wherein the SMTZ depth information is used to indicate a SMTZ depth region;

enabling the first control module to generate a first control instruction and send the first control instruction to a sample collection module based on the SMTZ depth information; wherein the first control instruction is used to instruct the sample collection module to perform pressure-retaining sampling at the target sampling site;

performing, by the sample collection module in response to the first control instruction, pressure-retaining sampling, and determining, by the sample collection module, sample thickness information of the sample collected; and

enabling the first control module to determine whether to generate a second control instruction based on the sample thickness information; wherein the second control instruction is used to instruct the sample collection module to release the sample and/or perform secondary sampling.

More specifically, referring to FIG. 6, preparations are made before the sampling apparatus is submerged, including cleaning the sampling apparatus and injecting a certain pressure into the energy storage chamber. Then, the sampling apparatus is transported to the target sampling site, where the first control module controls multiple methane sensors in the methane concentration detection array to penetrate into the sediments, so as to obtain methane concentration information and corresponding detection depth information at the target sampling site. SMTZ depth information is fitted based on the methane concentration information and the detection depth information. Next, the first control module controls the sampling chamber to press down and collect samples. After the sampling chamber collects the samples, the sampling chamber is controlled to rise, and then the pressure-retaining cylinder is controlled to translate to a position below the sampling chamber. The sampling chamber is moved down into the pressure-retaining cylinder, thereby completing the docking and sealing of the sampling chamber and the pressure-retaining cylinder, and the pressure-retaining, multi-medium, large-diameter sample collection. During sampling, the sonar mounted on the sampling chamber monitors the sediment and seawater thickness in the sample collected in real time, and transmits monitored data to the first control module. The first control module compares the sediment thickness in the sampling chamber with the calculated SMTZ depth information to determine whether the sample collected meets research requirements: if the sample collected meets research requirements, the sample collected and the sampling apparatus are pulled up to a deck for subsequent work; and if the sample collected does not meet requirements, the first control module sends an instruction to the second control module to release the sample collected. The sampling apparatus is moved to the next target sampling site for secondary sampling.

It can be understood that the method of this embodiment is applied to the apparatus of Embodiment 1, and options in Embodiment 1 are equally applicable to this embodiment and will not be described again here.

### EMBODIMENT 3

This embodiment provides a computer-readable storage medium, on which at least one instruction, at least one program, a code set, or an instruction set is stored. The at least one instruction, at least one program, code set, or instruction set is loaded and executed by a processor, so that the processor can execute part or all of steps of the method provided in Embodiment 2 of this application.

It can be understood that the storage medium may be transient or non-transient. By way of example, the storage medium includes but is not limited to a USB flash drive, mobile hard disk, read-only memory (ROM), random access memory (RAM), magnetic disk, or optical disk, and other media capable of storing program code.

By way of example, the processor may be a central processing unit (CPU), microprocessor unit (MPU), digital signal processor (DSP), field programmable gate array (FPGA), or the like.

By way of example, the read-only memory includes but is not limited to MASK ROM, PROM, EPROM, EEPROM, Flash, and the like.

By way of example, the random access memory includes but is not limited to DRAM, SRAM, SDRAM, DDR SDRAM, and the like.

In some embodiments, a computer program product is provided, and may be implemented by hardware, software, or a combination thereof. As a non-limiting example, the computer program product may be embodied as the storage medium, and may also be embodied as a software product, such as an SDK (Software Development Kit).

As a non-limiting example, a computer program product is provided, where the computer program product includes a computer program or computer-executable instructions, and the computer program or computer-executable instructions are stored in a computer-readable storage medium. The processor of the electronic device reads the computer program or computer-executable instructions from the computer-readable storage medium, and the processor executes the computer-executable instructions, so that the electronic device executes part or all of steps of the method described in the embodiments of this application.

In some embodiments, a computer program is provided, and includes computer-readable code, where when the computer-readable code runs on a computer device, the processor in the computer device executes part or all of steps of the method.

This embodiment further provides an electronic device, and the electronic device includes a memory and a processor, where the memory stores at least one instruction, at least one program, a code set, or an instruction set; and the processor, when executing the at least one instruction, at least one program, code set, or instruction set, implements part or all of steps of the method as described in Embodiment 2.

In some embodiments, a hardware entity of the electronic device is provided, and includes: a processor, a memory, and a communication interface; where the processor generally controls the overall operation of the electronic device; the communication interface is used to enable the electronic device to communicate with other terminals or servers via a network; the memory is configured to store instructions and applications executable by the processor, and may also cache data (including but not limited to image data, audio data, voice communication data, and video communication data) to be processed by the processor and various modules in the electronic device or data that has already been processed. The memory may be implemented by flash memory (FLASH), erasable programmable read-only memory (EPROM), electrically erasable programmable read-only memory (EEPROM), or random access memory (RAM).

The processor may include one or more processing elements. Therefore, the processor may include one or more integrated circuits (IC) configured to execute functions of the processor. Furthermore, each integrated circuit may include circuitry (for example, a first circuit, a second circuit, and other circuits) configured to execute the functions of the processor.

Further, data transmission among the processor, communication interface, and memory may be performed via a bus, and the bus may include any number of interconnected buses and bridges, connecting various circuits of one or more processors and memories together.

It can be understood that the options in Embodiment 1 or 2 above are equally applicable to this embodiment, and therefore will not be described again here.

Identical or similar reference numerals correspond to identical or similar components.

Terms describing positional relationships in the drawings are for exemplary illustration only and shall not be construed as limitations to this application.

It should be noted that the embodiments of this application can be mutually combined with the features in the embodiments without any conflict.

In different specific embodiments, the method or system described in this application may be implemented in software, hardware, or a combination thereof. Furthermore, the order of the steps of the method may be changed, and various elements may be added, reordered, combined, omitted, or modified.

Obviously, the above embodiments of this application are merely examples to clearly illustrate this application and are not intended to limit the implementations of this application, nor to limit this application. For those of ordinary skill in the art, other variations or modifications in different forms can be made based on the above description. The respective structural/functional modules or units may be integrated together to form an independent part, may exist separately, or two or more modules may be integrated to form an independent part. The structure and function of separate components may be implemented as a combined structure or component. It is neither necessary nor possible to exhaustively list all implementations herein. Any modifications, equivalent substitutions, improvements, and the like made within the spirit and principles of this application shall be included within the scope of protection of the claims of this application.

1. A multi-medium large-diameter fidelity sampling apparatus, comprising:
a methane concentration detection array, configured to detect methane leakage situation at a target sampling site and generate methane detection information, wherein the methane detection information comprises detection depth information and methane concentration information;
a first control module, configured to determine SMTZ depth information at the target sampling site based on the methane detection information; and further configured to determine a first control instruction based on the SMTZ depth information;
a sample collection module, configured to perform pressure-retaining sampling at the target sampling site in response to the first control instruction; and further configured to determine sample thickness information of a sample collected, and to release the sample and/or perform secondary sampling based on a second control instruction determined by the first control module in response to the sample thickness information;
wherein
the sample collection module comprises:
a sampling chamber, configured to perform sampling operations at the target sampling site and store the sample collected;
a sonar, provided within the sampling chamber, configured to determine whether the sample has been successfully collected in the sampling chamber, and to determine the sample thickness information of the sample;
an energy storage chamber, configured to inject a pressure and be connected to the sampling chamber via a piston to maintain a pressure of the sampling chamber;
a pressure-retaining module, configured to dock with the sampling chamber to perform pressure-retaining operations after the sampling operation is completed in the sampling chamber;
a second control module, configured to receive the first control instruction and/or the second control instruction, and to control the sampling chamber to perform the sampling operations and/or release operations based on the first control instruction and/or the second control instruction; and further configured to generate a third control instruction to control the pressure-retaining module to perform the pressure-retaining operations after the sampling operations are completed;
and
the determining SMTZ depth information at the target sampling site based on the methane detection information comprises:
performing linear fitting using at least three pieces of detection depth information and corresponding methane concentration information from the methane concentration detection array to obtain a depth at which a methane concentration is zero, wherein the depth is an SMTZ region where an AOM reaction is most intense and referred to as the SMTZ depth information.

2. The multi-medium large-diameter fidelity sampling apparatus according to claim 1, wherein the sample collection module further comprises an apparatus frame, and the second control module, the sampling chamber, the energy storage chamber, and the pressure-retaining module are provided within the apparatus frame.

3. The multi-medium large-diameter fidelity sampling apparatus according to claim 1, wherein the pressure-retaining module comprises a pressure-retaining cylinder and a third control module; wherein
one end of the pressure-retaining cylinder is provided with an opening for insertion into the sampling chamber; and
the third control module is configured to, in response to the third control instruction, control the pressure-retaining cylinder to move to a same axis as the sampling chamber, and orient the opening of the pressure-retaining cylinder towards the sampling chamber; and after the sampling chamber is placed into the pressure-retaining cylinder through the opening, the pressure-retaining cylinder is docked and sealed with the sampling chamber to complete an pressure-retaining operation.

4. The multi-medium large-diameter fidelity sampling apparatus according to claim 1, wherein the releasing the sample and/or performing secondary sampling based on the second control instruction determined by the first control module in response to the sample thickness information comprises:
determining, by the first control module, whether the sample collected meets preset requirements based on the sample thickness information acquired by the sonar: if the sample collected meets preset requirements, performing no operation; if the sample collected does not meet preset requirements, generating the second control instruction to instruct the sampling chamber to release the sample currently collected and/or to instruct the sampling chamber to perform sampling operation again; and
controlling, by the second control module, the sampling chamber to complete the release operation and/or the sampling operation in response to the second control instruction.

5. The multi-medium large-diameter fidelity sampling apparatus according to claim 1, wherein the determining SMTZ depth information at the target sampling site further comprises:
averaging a plurality of pieces of SMTZ depth information from a plurality of methane concentration detection arrays, and taking an average value obtained as final SMTZ depth information.

6. The multi-medium large-diameter fidelity sampling apparatus according to claim 1, wherein the methane concentration detection array comprises a plurality of methane detection modules distributed around the sample collection module; wherein each methane detection module comprises:
a methane sensor, configured to collect methane concentration information at the target sampling site;
a third control module, configured to control the methane sensor to penetrate into the sediments to obtain methane concentration information in sediments at different depths; and further configured to send the methane concentration information and corresponding detection depth information to the first control module; and
a protection apparatus, configured to accommodate the third control module and the methane sensor.

7. A multi-medium large-diameter fidelity sampling method, applied to the apparatus according to claim 1, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

8. A computer program product, comprising a computer program or computer-executable instructions, wherein when the computer program or computer-executable instructions are executed by a processor, the method according to claim 7 is implemented.

9. A multi-medium large-diameter fidelity sampling method, applied to the apparatus according to claim 2, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

10. A computer program product, comprising a computer program or computer-executable instructions, wherein when the computer program or computer-executable instructions are executed by a processor, the method according to claim 9 is implemented.

11. A multi-medium large-diameter fidelity sampling method, applied to the apparatus according to claim 3, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

12. A computer program product, comprising a computer program or computer-executable instructions, wherein when the computer program or computer-executable instructions are executed by a processor, the method according to claim 11 is implemented.

13. A multi-medium large-diameter fidelity sampling method, applied to the apparatus according to claim 4, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

14. A computer program product, comprising a computer program or computer-executable instructions, wherein when the computer program or computer-executable instructions are executed by a processor, the method according to claim 13 is implemented.

15. A multi-medium large-diameter fidelity sampling method, applied to the apparatus according to claim 5, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

16. A computer program product, comprising a computer program or computer-executable instructions, wherein when the computer program or computer-executable instructions are executed by a processor, the method according to claim 15 is implemented.

17. A multi-medium large-diameter fidelity sampling method, applied to the apparatus according to claim 6, comprising:
enabling a methane concentration detection array to penetrate into sediments at a target sampling site, obtaining methane leakage at different depths at the target sampling site, and generating methane detection information;
enabling a first control module to determine SMTZ depth information in response to the methane detection information; wherein the SMTZ depth information is used to indicate a SMTZ depth region;
enabling the first control module to generate a first control instruction and send the first control instruction to a sample collection module based on the SMTZ depth information; wherein the first control instruction is used to instruct the sample collection module to perform pressure-retaining sampling at the target sampling site;
performing, by the sample collection module in response to the first control instruction, pressure-retaining sampling, and determining, by the sample collection module, sample thickness information of the sample collected; and
enabling the first control module to determine whether to generate a second control instruction based on the sample thickness information; wherein the second control instruction is used to instruct the sample collection module to release the sample and/or perform secondary sampling.

18. A computer program product, comprising a computer program or computer-executable instructions, wherein when the computer program or computer-executable instructions are executed by a processor, the method according to claim 17 is implemented.
